(19) United States
(12) Patent Application Publication
(10) Pub. No.: US 2008/0239770 A1
(43) Pub. Date: Oct. 2, 2008

(54) Active Network Filter

(76) Inventors: Alfred Punzet, Erbach (DE); Viet Luu Hong, Quan Dong Da Hanoi (VN)

Correspondence Address: MICHAEL J. STRIKER, 103 EAST NECK ROAD, HUNTINGTON, NY, 11743, US

(21) Appl. No.: 12/065,065

(22) PCT Filed: Aug. 30, 2006
(86) PCT No.: PCT/EP2006/008462

§ 371 Date: Feb. 27, 2008

(30) Foreign Application Priority Data
Sep. 3, 2005 (DE) 10 2005 041 927.5

(51) Int. Cl. H02M 1/12

(52) U.S. Cl. 363/40

(57) ABSTRACT

The invention relates to a supply device (13) which feeds a consumer (7) with power by means of a supply network (12). Said supply device (13) fulfils both the function of a power supply and the function of a network filter, an optimum working point to be adjustable in terms of the operating modes as supplier/active filter, according to the required energy reserves. This is achieved by means of an active phase effect filter, a harmonic wave detection means (3) determining a compensating power dependent on the network harmonic wave power, and a control device component (5) whose action is adapted to the compensating power requirement being provided for the determination of an amplification factor (6). The compensating power is supplied to the current inverter according to the utilisation of the current inverter (1) and the amplification factor (6).

The present invention relates to a supply device according to the independent claims, in the case of which a supply network supplies consumers with power, and the influences of non-linear loads on the supply network are compensated for. The related art makes known systems with current inverters that may function as a supply device for providing electrical power for a DC intermediate circuit. In addition, current inverter systems are known, which are capable of compensating for harmonic currents in the network. The present invention describes, in detail, the parallel supply and compensation carried out using a system that may function as a supply device and an active filter.

An active network filter is basically composed of a current inverter or a PWM converter in an, e.g., 3-phase design with IGBT bridges, which is capable of feeding electrical power to a DC intermediate circuit, and of absorbing power. The currents that result may include power components and quadrature components. The current inverter is typically connected with the actual supply network using a network interface that includes a line reactor, and is therefore connected between the load and the network.

Additional non-linear loads may also be connected to the supply network. A simple diode rectifier bridge is an example of a non-linear load of this type. A more complex configuration, such as a drive system with electrical consumers, also causes non-linear distortions. The non-linear load results in a network being loaded with currents filled with harmonic waves. These currents disturb the network balance and cause currents in the middle conductor. This may result in problems with devices that are connected in parallel. Depending on where they occur, these problems are manifested differently as power overloads, voltage drops at the middle conductor, component overload by the harmonic waves (transformers, capacitors), and malfunctions due to the non-sinusoidal network.

Devices are known in the related art that restore network balances of this type. Devices of this type are referred to as “active network filters”.

For example, publication JP 9258839 presents a relevant active filter, with which the degree of compensation of the non-linear components may be adjusted using an adjustable K factor. To determine the compensating current, individual harmonic waves are filtered out using a FFT (fast Fourier transform). The K factor serves to adjust the filter in an energy-saving manner, and serves no other function.

The object of the present invention is to improve a supply device of the type described initially such that an operating point that is optimal in terms of the network balance may be set in terms of the operating modes as a supplier and filter, depending on the energy reserves required.

The present invention attains the object by using an active phase effect filter with a current inverter, a control device, and harmonic wave detection means. The harmonic wave detection means determine a compensating power (pc, qc) that is dependent on the network harmonic wave power. A control device component whose action is actively adapted to the compensating power requirement is provided in order to determine an amplification factor. The compensating power is supplied to the current inverter according to the utilization of the current inverter and/or the amplification factor.

The active filter described above, which has been modified according to the present invention, is preferably connected to a 3-phase network using a network filter. The network filter provides filtering on the supply network side to reduce the operating frequency, which is generated by the PWM stage of the current inverter and is superposed on the network frequency.

The power component of the current inverter includes a PWM-IGBT end stage with a DC voltage intermediate circuit, including an intermediate circuit capacitor. A DC load is typically connected on the intermediate circuit side. The current inverter is the supplier for this load.

In general, it should be noted that the supply network may also include more or fewer than 3 phases. The present invention is therefore not limited to the use of a 3-phase supply network.

A control device is understood to be a unit that includes components for operating the current inverter, in particular components for monitoring, controlling, and regulating the power output. All performance data on the current inverter may be stored in the control device. This data may include the permissible maximum current Imax, the permissible maximum voltage Umax, the thermal characteristic curve of the current inverter, the extent of the instantaneous capacity utilization/load, the maximum possible performance output, etc. The control device may also include the harmonic wave detection means and the adaptive control device components.

“Harmonic wave detection means” are understood to be a device that is capable of mathematically determining the portion of non-linear distortions in the current and/or voltage shape of a supply network, and, therefore, the active power component and the reactive power component in the supply network.

An “actively adapted control device component” is understood to be a device that determines a compensation factor, with which the quality of the active filtering may be adjusted depending on the energy that is required and the energy that is available (actual capacity of the current inverter and/or the state of the DC voltage intermediate circuit). Using this measure, a lower filter quality may be set in exchange for an increased power requirement of a DC load connected to the current inverter. A practically stepless transition between the two operating modes “supplier” and “filter” may therefore be created.

The wording “according to the capacity utilization of the current inverter” is understood to mean the instantaneous extent of capacity utilization/load of the current inverter as a supplier-dependent regulation of the compensating power.

The inventive active filter therefore has two possible operating modes. A first operating mode is that of a network filter for compensating for non-linear distortions, and a second operating mode is that of a supplier for a load connected on the DC intermediate circuit side. Both of the operating modes may be active in parallel or in an alternating manner, with different intensity. Given the fact that the necessary compensating power is transformed into a compensating current reference value, according to the capacity utilization of the current inverter and the adaptively determined amplification factor, the extent of compensation may be regulated and adjusted in an individualized manner. The phase effect filter may therefore be operated simultaneously as a voltage supply device (supplier) or as a filter, depending on the harmonic waves created by a non-linear load. The function of a power supply and the function of a network filter are therefore both fulfilled, and an optimal operating point with regard for the supplier/filter operating modes may therefore be adjusted, depending on the energy reserves required.

Particularly preferably, using the phase effect filter mentioned above, the compensating power and, possibly, the P_{dc} power requirement of a DC load connected to the current inverter at the input of a current transformer is/are taken into consideration and is/are transformed into compensating current reference values (I*q,I*d) using the current transformer. The transformation of power into current that takes place in this processing step has the advantage that the variables acted upon by the amplification factor and the output of the voltage regulator are independent of the level of the network voltage. Up to this point, calculations may be carried out at the power level.

The DC voltage U_{DC} is an intermediate circuit voltage that is generated by the current inverter and to which a load to be supplied with direct current is typically connected. By taking the connectable load into account in the manner described, it is possible to give priority to one of the operating modes of the current inverter (supplier and/or filter), thereby resulting in a selection of the operating mode that is load-dependent. If large non-linearities are to be compensated for, for example, the filter operating mode would be given priority, provided sufficient power remains to supply additional loads.

Very particularly preferred, the inventive phase effect filter includes a current control, in particular a PI current control with dead-beat behavior. The advantage of using dead-beat behavior as compared with the pure PI behavior is that the currents are adjusted more quickly, which therefore results in the compensated current waveform being adjusted more exactly.

Advantageously, an inventive active phase effect filter includes a voltage regulator whose input-side system deviation is determined based on a DC voltage present at the DC voltage output of the current inverter and a DC voltage reference value, and with which the output value of the voltage regulator corresponds to an active power reference value. The regulator may be a PI voltage regulator. A power reference value on the intermediate circuit side may therefore be easily determined based on the intermediate circuit voltage.

The harmonic wave detection means preferably include an AC supply voltage and AC supply currents, and they convert them into compensating power reference values pc, qc, which are depictable in the dq coordinate system using the Clarke transformation according to the active-reactive power theory (PQ theory). The input variable of the harmonic wave detection means may be a 3-phase supply network current or a 3-phase supply network voltage of the supply network, to which a non-linear load is connected, and whose harmonic wave components are to be compensated for. When summed with the supply network power—which includes harmonic waves—at the network supply points, the corrected powers that are determined result in sinusoidal active power. An efficient and reproducible method is therefore created for mathematically determining the power to be compensated for.

Particularly preferably, the actively adapted control device components include a control loop for calculating the amplification factor, in the case of which the amplification factor functions as a control element and controls the component of the compensating power. The quality with which a compensation is carried out depends, e.g., on the performance of the control loop.

Very particularly preferably, the intensity of the compensation may be regulated in a practically stepless manner between a state without compensation (with the device in the supplier mode) and a state of maximum possible compensation (with the device in the filter mode), or in a sub-range located within the state range described above. The inventive phase effect filter may therefore be regulated steplessly between the two operating modes—“filter” and “supplier”—depending on the load conditions.

Advantageously, the amplification factor is determined as a function of the square of the maximum current of the inverter and the square of the compensating current reference values, based on the decision ε=(iₘₐₓ²−(i*_{d}²+i*_{q}²))>0. Given that the vectors are calculated and the total vector lengths are taken into account by squaring the currents, it is prevented that the maximum current of the inverter will be exceeded.

To further optimize the behavior of the system in real operation, when the amplification factor is calculated, additional influencing factors are taken into account, particularly the thermal behavior of the current inverter, and the amplification factor is advantageously determined as a function of the load that is connectable to the current inverter, thereby making it possible to realize a basic load compensation and/or a peak load compensation for this load during the filtering operation.

According to the level of the non-linear network load, it may therefore be defined whether and/or with what intensity a compensation is carried out that is a function of the network harmonic wave power. Depending on the type of network, the requirements of the energy supplier, or the guidelines of the connected consumers, it is therefore possible to react in a flexible manner.

According to another possibility for attaining the object of the present invention, an active phase effect filter described initially—which has the properties described above, in particular—is assignable, as a slave, to a master in the form of a central control device (9), and an input and/or output is included for connection with the master, it being possible to receive a compensating power reference value via the input. It would therefore be possible to operate the active phase effect filter autonomously or centrally, in a network of active phase effect filters.

The output serves to transmit static and/or dynamic device data on the current inverter to the central control device, where the individual compensating power components that are appropriate for the current inverter are computed. It is possible to transmit current converter-specific data to the master via the output, in particular data related to the performance and/or capacity utilization/load of the current inverter, and the DC voltage intermediate circuit power P_{dc}.

The present invention also includes a central control device, which may be assigned, as a master, to a slave, in the form of an inventive phase effect filter, and which includes an input and/or output for connection with a slave, it being possible to transmit compensating power reference values via the output. A control device may therefore control several active network filters.

Advantageously, it is possible to receive current converter-specific data from the slave via the input, in particular data related to the performance and/or capacity utilization/load of the current inverter. It is then possible to perform individual calculations as a function of power, and these calculations may be repeated in a cyclic manner.

Particularly preferably, the central control device includes harmonic wave detection means, which determine a compensating power that is a function of the mains harmonic wave power. A control device component whose action is actively adapted to the compensating power requirement is provided in order to determine an amplification factor, the compensating power serving as compensating power reference value according to the capacity utilization/load of the current inverter and the amplification factor. The advantages result from the designs for an active phase effect filter with an integrated control device.

An inventive supply network includes at least one inventive active phase effect filter and/or one central control unit. The advantages described above are referred to here.

Preferably, the non-linear load is a drive system, in particular a drive system with further electrical components. With these systems in particular, non-linear distortions occur due to the use of non-linear components.

### REFERENCE NUMERALS

1 Current inverter

2 Control device

3 Harmonic wave detection means

4a Current control

4b Current transformer

5 Adaptive controller

6 Amplification factor

7 DC load

8 PI controller

9 Master controller

10 Non-linear load

11 Network interface

12 Supply network

13 Active phase effect filter

14 Connection

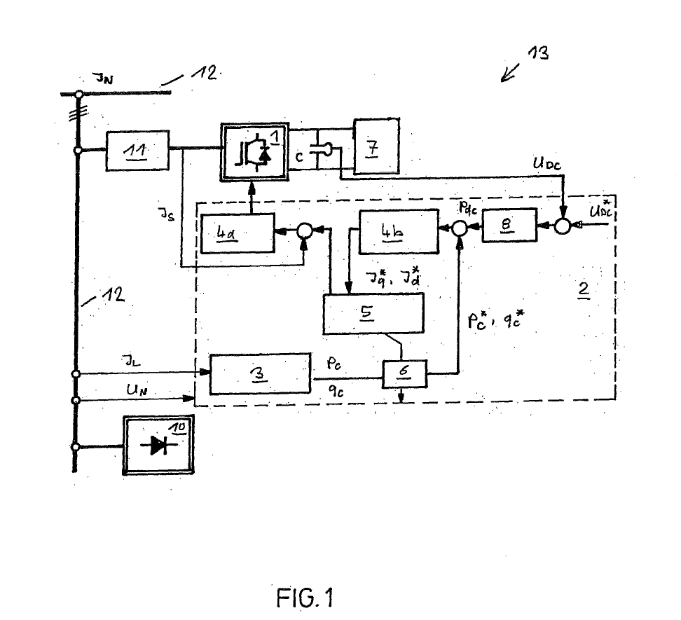

The present invention is described in greater detail below with reference to the examples depicted in FIGS. 1 through 3.

FIG. 1 shows a control scheme for an active phase effect filter, including peripherals:

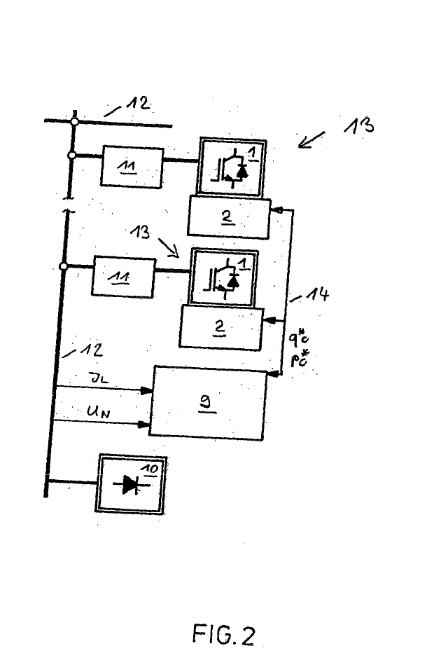

FIG. 2 shows a schematic block diagram of a supply network with a central control device and several inventive devices;

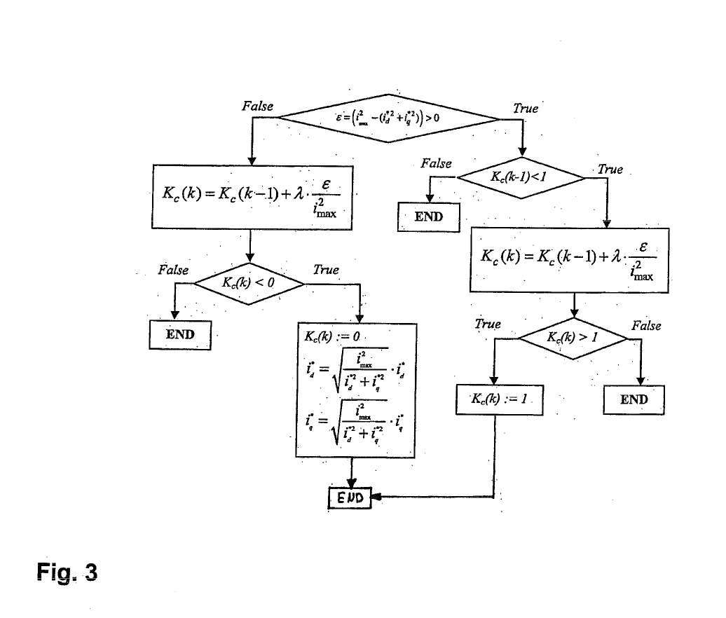

FIG. 3 shows a flow chart for determining the amplification factor.

A current inverter 1 with DC load 7 and a control device 2 are shown in FIG. 1. Control device 2 includes, in particular, current control 4a, a voltage transformer 4b, harmonic wave detection means 3, an adaptive controller 5, a PI regulator 8, and an amplification factor Kc 6. Current inverter network current I_{S} that is measured is sent to control device 2 after passing through network interface 11. Supply network current I_{L} of the non-linear load and supply network voltage U_{N} are also sent to control device 2. A non-linear load 10 is also connected to supply network 12. I_{L} is the distorted current of non-linear load 10, and I_{S} is the current inverter output current. I_{S} contains the current difference required to form a sinusoidal network current I_{N} from distorted current I_{L}.

When current inverter 1 is triggered in the suitable form by using current uptake I_{L} of non-linear load 10 as the measured quantity, it is possible to influence the current on the supply network side at any time in such a manner that more or less sinusoidal network current I_{N} arises. Given that current measurement of this type and the related control algorithms are added to current inverter 1, it is possible to speak of an active network filter 13. It is also active because the filtering is based not only on classical low-pass filters with inductances (L) and capacitances (C).

Active phase effect filter 13 includes, e.g., a fully functional current inverter 1, thereby making it possible to switch between the operating modes of “filter mode” and “supplier mode”, or to activate them simultaneously or separately using suitable control algorithms that run in control device 2. Basically, the control algorithm calculates the current reference values for active power and reactive power. They are required in order to completely compensate for the effects of a non-linear load. This compensation ability is limited by the current limit and/or the performance of the active filter.

Harmonic wave detection means 3 determine a compensating power that is dependent on the network harmonic wave power on the supply network side with power component pc and quadrature component qc. Component 5, which is actively adapted with regard for the compensating power requirement, is used to determine amplification factor 6. Compensating power pc, qc that has been computed is forwarded according to the performance and/or capacity utilization/load of current inverter 1 and using amplification factor 6, in the form of adaptive compensating power values p*c and q*c, which are transformed by current transformer 4b with consideration for active power reference value P_{dc} into compensating current reference values I*q; I*d, and they are sent to adaptive controller 5. Based on compensating current reference values I*q, I*d and current inverter network current I_{S} that was measured (with consideration for the active and quadrature components per the Clark-dq transformation), a system deviation is calculated, and related voltage reference values Uq and Ud are sent to current inverter 1 for compensating purposes using current control 4a. To account for the power requirement of DC load 7 in the filter mode, compensating current reference values I*q, I*d are supplied, depending on the load on DC supply voltage U_{DC} present at the DC voltage output of current inverter 1. To incorporate U_{DC}, a voltage regulator 8 is included, the input-side system deviation of which is determined based on DC voltage U_{DC} and a DC voltage reference value U*_{DC}, and the output value of which corresponds to active power reference value P_{dc}. The active power reference value P_{dc} that is computed is added to compensating power reference value p*c.

The supply system shown in FIG. 2 includes a supply network 12 and several inventive active phase effect filters 13 with peripherals 10, 11. Active phase effect filter 13 includes a current inverter 1 and a control device 2, as explained above. The interruption in supply network 12 shown serves to indicate that a larger number of additional active phase effect filters 13 could be connected to supply network 12. The peripherals can include, e.g., network interface 11. A non-linear load 10 and a central control unit (master controller) 9 are also shown.

Bidirectional and/or unidirectional connections 14 are provided between control devices 2 of active phase effect filter 13 and master controller 9. Master controller 9 may therefore communicate with control devices 2, which are designed as slaves. Via connection 14, it is possible, e.g., to transfer compensating power reference values p*c, q*c from master controller 9 to control devices 2. The reference value is then transformed into compensating current reference values I*q, I*d using a decentralized current transformer 4b included in phase effect filter 13. A current control 4a uses these compensating current reference values I*q, I*d to generate voltage reference values Uq, Ud, which are sent to current inverter 1 for compensating purposes. This current transformation and current control preferably take place in control device 2 (see FIG. 1).

In turn, master controller 9 may use connection 14 to receive and evaluate current converter-specific data, in particular data related to the performance and/or capacity utilization/load of current inverter 1. Central control device 9 or master controller 9 includes harmonic wave detection means 3. Harmonic wave detection means 3 determine compensating power pc, qc, which are dependent on the network harmonic wave power as described above. An amplification factor 6 (K_{C}) is determined in a control device component 5 whose action is actively adapted to the compensating power requirement. Amplification factor 6 determines the compensating power required for the current inverter according to the individual performance and/or capacity utilization, based on the data from the current inverter received via connection 14.

Non-linear load 10 could be, e.g., a drive system, in particular a drive system with further electrical components. FIG. 2 is absolutely not intended to indicate that only one non-linear load 10 may be supplied with power from the supply network. Instead, non-linear load 10 is representative of further non-linear loads that may be connected in parallel and/or in series. The combination of non-linear loads 10 generates a harmonic wave picture that is specific for this configuration. This harmonic wave picture is registered by master controller 9, in order to influence it in a highly targeted manner.

In summary, using a central control device 9, it is possible to perform a complete or partial and dynamically adapted compensation of the harmonic waves of supply network 12 using several current inverters 1, while also accounting for the power reserves/capacity utilization/load of available current inverters 1. One application of this would be, e.g., a production station on a production line with several drive systems composed of active phase effect filters 12 which, due to current inverter 1, may also function as a regenerative supplier. The DC loads may be axial current inverters and motors. In this example, non-linear loads 10 could be composed of supply devices with infeed capability (rectifier bridges) and connected axial current inverters, and further consumers that will not be described in greater detail. Depending on the requirement, the system is therefore partially equipped with supply devices with infeed capability (non-linear load due to the rectifier bridge) and with regenerative capability (a current inverter, and therefore capable of functioning as a supplier or an active filter).

Adaptively active control device component 5 in FIG. 5 (included in master controller block 9 in FIG. 2) includes a control loop for calculating amplification factor 6. As shown in FIG. 1, and as indicated with an arrow, amplification factor 6 functions as a control element, and it controls the portion of compensating powers pc and qc required to calculate the system deviation at the input of current transformer 4b. After multiplication with the amplification factor, the adapted compensating powers p*c, q*c are available. As a result, the intensity of compensating current I*q, I*d may be regulated directly using amplification factor 6.

Amplification factor 6 is determined as a function of the square of the maximum current of the inverter (Imax) and the square of the compensating current reference values I*d, I*q, based on the decision ε=(i*ₘₐₓ²−(i*_{d}²+i*_{q}²))>0. Additional information regarding the determination of amplification factor 6 is provided in FIG. 3.

FIG. 3 shows a flow chart for calculating amplification factor 6 (K_{c}). In this diagram, decisions defined using formulas are presented using diamond-shaped symbols, and instructions are presented using rectangular symbols. The terms “true” and “false” indicate whether a basic decision (diamond) has been met or not. Branching off takes place depending on the result of the comparison. The term “end” means that use of the algorithm has been halted until the next calculation interval.

The variables and terms used in the Figure will be defined briefly.

Adaptive amplification factor K_{c} controls the portion of compensating power values pc, qc that were calculated, and which are used for the active network filtering. In this example, a factor K_{c} of 0 means that no active network filtering is taking place. In this example, a factor of 1 means that complete network filtering is taking place. Amplification factor 6 (K_{c}) should therefore be in the range: 0≦Kₓ≦1. Adaptive amplification factor 6 (K_{c}) is always recalculated as a function of ε using control device 5 in a cyclical manner, as shown in the flow chart.

K_{c(k)} represents the current value, and K_{c(k-1)} represents the value of the previous calculation.

I*d, I*q represent the compensating current reference values calculated in current transformer 4b with consideration for supply network phase angle φ. The compensating current reference values are depictable in an orthogonal dq coordinaten system. The input quantities of current transformer p*c and q*c are already in the dq system. Network voltage U_{N} is taken into account using a network voltage U_{N}, which was transformed in an αβ-system (transformation of a three-phase system with phases a,b,c into a two-phase system with phases α, β). Ua,b,c represents the three phases of network voltage U_{N}. The conversion is carried out using the following calculation. Reference is made to the pertinent literature for further details regarding the αβ-transformation.

$$[ \begin{matrix}{u}_{α} \\ {u}_{β}\end{matrix} ] = \sqrt{\frac{2}{3}} [ \begin{matrix}1 & - 1 / 2 & - 1 / 2 \\ 0 & \sqrt{3} / 2 & - \sqrt{3} / 2\end{matrix} ] [ \begin{matrix}{u}_{a} \\ {u}_{b} \\ {u}_{c}\end{matrix} ]$$

with p=(p*c+Pdc) and q=q*c (refer to the system deviation sent to current transformer 4b in FIG. 1):

$$[ \begin{matrix}{i}_{α} \\ {i}_{β}\end{matrix} ] \frac{1}{( {u}_{α}^{2} + {u}_{β}^{2} )} [ \begin{matrix}{u}_{α} & {u}_{β} \\ {u}_{β} & - {u}_{α}\end{matrix} ] [ \begin{matrix}p \\ q\end{matrix} ]$$

I*d and I*q are calculated as:

I*d=iα*cos φ+iβ*sin φ

I*q=−iα*sin φ+iβ*cos φ

Maximum current Iₘₐₓ of current inverter that is possible at that instant applies for the vectors sum of currents in the dq direction. By definition, the d component represents the power component. The instantaneously possible maximum current of converter I²ₘₐₓ (vector addition) is provided from an external source, and, in the simplest case, may be a fixed value. A further possibility would be to obtain it using a thermal model of the PWM end stage. By comparing I²ₘₐₓ with compensating current reference values I*d I*q, the extent to which the current inverter is being utilized is determined. Using the instantaneous capacity utilization it is possible to derive a strategy of how the current inverter should behave for the next time interval.

The actual current reserve E for active filtering is calculated from the geometric subtraction of currents Iₘₐₓ and I*d, I*q.

In the present embodiment, amplification factor (6) K_{c} is calculated using a discrete proportional controller. Proportional amplification factor λ is used to adjust the amplification of the control loop.

When the actual current reserve is ε>0, i.e., current may be provided for the “active network filtering” operating mode, the controller is notched up and adaptive amplification factor K_{c} is increased. When the limit value of K_{c}=1 has been attained, it is limited at this value.

When the actual current reserve is ε<0, i.e., no current may be provided for the “active network filtering” operating mode, the controller is notched down and adaptive amplification factor K_{c} is reduced. When the lower limit value of K_{c}=0 has been attained, it it limited at this value.

In the borderline case K_{c}=0, the compensating current values are set equal to zero. The current component from the voltage regulation for U_{DC} is not affected, however. An additional calculation is therefore performed only when K_{c}=0. In this calculation, current references values I*d, I*q from the normal supplier regulation are limited, in terms of the components. Since the individual vector lengths are determinative, this limiting process must be performed using vectors.

Since the intermediate circuit power P_{dc} component is not multiplied by amplification factor K_{c}, higher priority is always given to providing active power and, therefore, the operating mode of the entire device as a supplier over the operating mode as an active supply network filter.

The problem arises that the PWM end stage may be at full thermal capacity already due to the active filtering, even in the absence of an active power requirement. The maximum current of the converter I²ₘₐₓ possible at that instant would be reduced due to the thermal load, and the filtering capability would therefore also be reduced. If active power would now be required, the compensating current reference values would have to be lowered. The current that becomes available for the required active power would now be insufficient, due to the thermally-induced reduction in I²ₘₐₓ. To account for this case as well, maximum current of the converter I²ₘₐₓ possible at that instant may be reduced to previously defined current I²_{dcmax}. The level of I²_{dcmax} may be predetermined for the particular application, depending on the expected load or capacity of the current inverter. It is therefore always possible to occupy an active power reserve that may not be fallen below by the thermal load in the filter mode.

The active principle may be reversed by switching the calculation algorithm (FIG. 3) accordingly and locating factor K_{c} in the range of P_{dc}. It would therefore be possible to give priority to the operation as an active filter, at the expense of providing energy as a supplier, of course.

When calculating amplification factor 6 (K_{c}), it is also possible to take additional influencing factors into account, in particular the thermal behavior mentioned above. These factors basically act on default value I²ₘₐₓ.

It would also be possible to design control device components 5 such that filtering is always carried out in an optimal manner up to a freely definable, non-linear load value 10. The result would be that current inverter 1 would always operate as a filter with a basic load due to the compensation of non-linear distortions in supply network 12, and as a supply device at supply network 12. Peak loads, which occur less frequently, would be partially compensated for. It is also possible to eliminate compensation entirely when there are low, non-linear loads on supply network 12, in order to only compensate for high, non-linear peak loads. A configuration of this type may be realized using specially designed control characteristic curves. Depending on the shape of the curve of the control characteristic line s, p*c,q*c is obtained from s(pc,qc)×pc,qc. In the illustration, pc′=pc* and qc′=qc*.

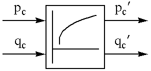

The control characteristic curve may be inserted after harmonic wave detection means 3, and it acts as an additional non-linear amplification factor.

What is claimed is:

1. An active phase effect filter with a current inverter (1), a control device (2), and harmonic wave detection means (3),
wherein
the harmonic wave detection means (3) determine a compensating power (pc, qc) that is dependent on the network harmonic wave power, and a control device component (5) whose action is actively adapted to the compensating power requirement is provided in order to determine an amplification factor (6); the compensating power (pc, qc) is supplied to the current inverter (1) according to the utilization of the current inverter (1) and/or the amplification factor (6).

2. An active phase effect filter as recited in claim 1, with which the compensating power (pc, qc) is transformed using a current transformer (4b) into a compensating current setpoint value (I*q,I*d).

3. An active phase effect filter as recited in claim 2, with which the load on a DC voltage (U_{DC}) that is measurable at the DC voltage output of the current inverter (1) is accounted for in the current transformation (4b) using an active power reference value (P_{dc}).

4. An active phase effect filter as recited in claim 1, with which current regulation (4a) is included, preferably current regulation (4a) with PI and dead-beat behavior.

5. An active phase effect filter as recited in claim 1, with which a voltage regulator (8) is included whose input-side system deviation is determined based on a DC voltage (U_{DC}) present at the DC voltage output (U_{DC}) of the current inverter (1) and a DC voltage reference value (U*_{DC}), and with which the output value of the voltage regulator (8) corresponds to an active power reference value (P_{dc}).

6. An active phase effect filter as recited in claim 1, with which the harmonic wave detection means (3) detects at least AC supply voltage (U_{N}) and/or an AC load current (I_{L}), converts it using the Clarke transformation, and determines the compensating power reference values (pc, qc)—which are depictable in the dq coordinate system—according to the active-reactive power theory (PQ theory).

7. An active phase effect filter as recited in claim 1, with which the adaptively active control device component (5) includes a control loop for calculating the amplification factor (6).

8. An active phase effect filter as recited in claim 1, with which the intensity of the compensating power (pc, qc) may be regulated.

9. An active phase effect filter as recited in claim 1, with which the amplification factor (6) is determined as a function of the square of the maximum current of the inverter (Imax=imax) and of the square of the compensating current reference values (I*d=i*d, I*q=i*q), based on the decision ε=(iₘₐₓ²−(i*_{d}²+i*_{q}²))>0.

10. An active phase effect filter as recited in claim 1, with which additional influencing factors—in particular the thermal behavior of the current inverter (1)—are taken into account in the calculation of the amplification factor (6).

11. An active phase effect filter as recited in claim 1, with which the amplification factor (6) is determined as a factor of the load (7) that is connectable to the current inverter (1), thereby making it possible to simultaneously realize basic load compensation and/or peak load compensation for the supply network (12) during the filtering operation.

12. An active phase effect filter as recited in claim 1, with which the intensity with which a compensation is carried out is definable according to the magnitude of a non-linear network load (10) connected to the supply network (12).

13. An active phase effect filter as recited in claim 1,
wherein
it is assignable, as a slave, to a master in the form of a central control device (9), and an input and/or output is included for connection (14) with the master (9), it being possible to receive a compensating power reference value (p*c, q*c) via the input.

14. An active phase effect filter as recited in claim 13, with which it is possible to transmit current inverter-specific data to the master (9) via the output, in particular data related to the performance and/or capacity utilization/load of the current inverter.

15. A central control device,
wherein
it is assignable, as a master (9), to a slave in the form of an active phase effect filter (13) as recited in claim 13, and an input and/or output for connection (14) with the slave (13) is included, it being possible to transmit a compensating power reference value (p*c, q*c) via the output.

16. The central control device as recited in claim 15, with which it is possible to receive current inverter-specific data from the slave (13) via the input, in particular data related to the performance and/or capacity utilization/load of the current inverter.

17. The central control device as recited in claim 15, which includes a harmonic wave detection means (3), which determines a compensating power (pc, qc) that is a function of the network harmonic wave power; a control control device component (5) whose action is actively adapted to the compensating power requirement is provided in order to determine an amplification factor (6), the compensating power serving as compensating power reference value (p*c, q*c) according to the capacity utilization/load of the current inverter (1) and the amplification factor (6).

18. A supply network,
wherein
it includes an active network filter (13) as recited in claim 1.

19. The supply network as recited in claim 18, with which a drive system is included as the non-linear load (10), in particular a drive system with further electrical components.
